(19) United States
(12) Patent Application Publication
(10) Pub. No.: US 2020/0082775 A1
(43) Pub. Date: Mar. 12, 2020

(54) DISPLAY DRIVING METHOD, DISPLAY DRIVING DEVICE AND DISPLAY DEVICE

(71) Applicants: HKC Corporation Limited, Baoan Dist Shenzhen (CN); Chongqing HKC Optoelectronics Technology Co., Ltd., Banan, District Chongqing (CN)

(72) Inventor: YU-JEN CHEN, Chongging (CN)

(21) Appl. No.: 15/744,838

(22) PCT Filed: Sep. 1, 2017
(86) PCT No.: PCT/CN2017/100253

§ 371 Date: Jan. 15, 2018

(30) Foreign Application Priority Data
Dec. 8, 2016 (CN) 201611122571.8

(51) Int. Cl. G09G 3/36

(52) U.S. Cl. CPC G09G 3/3674; G09G 2310/08; G09G 2310/021; G09G 3/3685

(57) ABSTRACT

A display driving method, a display driving device and a display device are provided. The display driving method includes the steps of: receiving an input image signal and decoding the input image signal into a first image signal and a fourth image signal; reproducing the first image signal to obtain a second image signal and a third image signal and reproducing the fourth image signal to obtain a fifth image signal and a sixth image signal; and inputting the second image signal, the third image signal, the fifth image signal and the sixth image signal to a display panel and displaying an image in conjunction with a gate driving signal.

### CROSS-REFERENCE TO RELATED APPLICATION

This application claims the benefit of China Patent Application No. 201611122571.8, filed on Dec. 8, 2016, in the State Intellectual Property Office of the People's Republic of China, the disclosure of which is incorporated herein in its entirety by reference.

### FIELD OF THE INVENTION

The present invention relates to the liquid crystal display technology, and more particularly to a display driving method, a display driving device, and a display device.

### BACKGROUND OF THE INVENTION

In general, the glass panel of a UD (Ultra High Definition) TV uses a UD TCON (Timer Control Register, i.e., a logic board) to design the PCBA (Printed Circuit Board Assembly) for displaying the UD glass panel.

In the process of producing TVs, there may be some defective products of UD glass panels. The defective products are usually sold at a lower price. However, the existing solution still uses the expensive UD TCON design to drive the glass panels. As a result, the overall cost of the defective products of UD glass panels is still high.

### SUMMARY OF THE INVENTION

The primary objective of the present invention is to provide a display driving method executed by a computer apparatus, which can reduce the overall cost of the defective products of UD glass panels.

In order to achieve the aforesaid objective, the display driving method executed by the computer apparatus of the present invention is applicable to an ultra-high definition display panel. The ultra-high definition display panel is driven by a FHD logic board. The display driving method comprises the steps of:

receiving an image signal as inputted and decoding the image signal into a first image signal and a fourth image signal;

reproducing the first image signal to obtain a second image signal and a third image signal and reproducing the fourth image signal to obtain a fifth image signal and a sixth image signal; and

inputting the second image signal, the third image signal, the fifth image signal and the sixth image signal to the display panel to display an image in conjunction with a gate driving signal.

In one embodiment, the gate driving signal drives scan lines of the display panel in pairs.

In one embodiment, the second image signal and the third image signal are differential signals.

In one embodiment, the step of reproducing the first image signal to obtain the second image signal and the third image signal and reproducing the fourth image signal to obtain the fifth image signal and the sixth image signal includes:

receiving the first image signal as inputted after signal lines of the second image signal are each connected with signal lines of the third image signal and receiving the fourth image signal as inputted after signal lines of the fifth image signal are each connected with signal lines of the sixth image signal.

In one embodiment, the second image signal, the third image signal, the fifth image signal and the sixth image signal are grouped as two lines of pixel signals, respectively.

In one embodiment, the display panel includes M source drivers and M gate drivers, and M is a positive integer.

In one embodiment, each of the source drivers includes one clock line, six data lines, and one data transmission trigger line.

According to another aspect of the present invention, a display driving device is provided. The device comprises a decoding module, a decoding module, and a driving module. The decoding module receives an input image signal and decodes the input image signal into a first image signal and a fourth image signal. The timing processing module reproduces the first image signal to obtain a second image signal and a third image signal and reproduces the fourth image signal to obtain a fifth image signal and a sixth image signal. The driving module inputs the second image signal, the third image signal, the fifth image signal and the sixth image signal to a display panel to display an image in conjunction with a gate driving signal.

In one embodiment, the gate driving signal drives scan lines of the display panel in pairs.

In one embodiment, the second image signal and the third image signal are differential signals.

In one embodiment, the timing processing module is used for receiving the first image signal as inputted after signal lines of the second image signal are each connected with signal lines of the third image signal and receiving the fourth image signal as inputted after signal lines of the fifth image signal are each connected with signal lines of the sixth image signal.

In one embodiment, the display panel includes M source drivers and M gate drivers, and M is a positive integer.

In one embodiment, each of the source drivers includes one clock line, six data lines, and one data transmission trigger line.

According to a further aspect of the present invention, a display device is provided. The display device comprises a display panel, a driving component; and a display driving device. The display driving device comprises a decoding module, a decoding module, and a driving module. The decoding module receives an image signal as inputted and decodes the image signal into a first image signal and a fourth image signal. The timing processing module reproduces the first image signal to obtain a second image signal and a third image signal and reproduces the fourth image signal to obtain a fifth image signal and a sixth image signal. The second image signal, the third image signal, the fifth image signal and the sixth image signal are grouped as two lines of pixel signals, respectively. The driving module inputs the second image signal, the third image signal, the fifth image signal and the sixth image signal to the display panel to display an image in conjunction with a gate driving signal.

The technical solution of the present invention is that the input FHD image signal is decoded to obtain the first image signal and the fourth image signal, and the first image signal is reproduced and divided into two lines of identical signals, and the right section image signal is reproduced and divided into two lines of identical signals so as to obtain four lines of image signals required for the UD display panel, i.e. the second image signal, the third image signal, the fifth image signal and the sixth image signal, in which, in conjunction with the gate driving signal of the display panel, the FHD image signal is displayed on the UD display panel. Compared to the conventional UD driving method, through the FHD driving method to display the FHD image signal on the UD display panel, the hardware cost is greatly reduced, thereby reducing the overall cost of the defective products of the UD glass panels.

### BRIEF DESCRIPTION OF THE DRAWINGS

In order to illustrate the technical feature of the present application in a clear manner, brief introductions for the drawings that accompany the illustrations of the embodiments will be given hereinafter; it is appreciated that the following drawings are merely for some embodiments of the present application, and a person skilled in the art can come up with other drawings according to the drawings provided herein without much inventive endeavors.

FIG. 1 is a flow chart of a display driving method in accordance with one embodiment of the present invention;

FIG. 2 is a schematic view showing a FHD image signal based on a UD display panel;

FIG. 3 is a schematic view showing a functional module of a display panel drive;

FIG. 4 is a schematic view showing the structure of a display driving device of the present invention;

FIG. 5 is a schematic view showing the source to drive partial lines at the right side of FIG. 4;

FIG. 6 is a schematic view showing the gate drive waveform timing sequence of the present invention; and

FIG. 7 is a schematic view showing a functional module of a display driving device in accordance with one embodiment of the present invention.

Embodiments of the present invention will now be described, by way of example only, to show the realization of objectives, functional characters and benefits with reference to the accompanying drawings.

### DESCRIPTION OF THE PREFERRED EMBODIMENTS

The following contents combined with the drawings for the embodiments of the present application serve to illustrate the technical features of the present application in a clear and thorough manner; it is apparent that the embodiments discoursed hereinafter is just part of the embodiments of the present application, and should not be construed as all of the embodiments of the present application. It is understood that any other embodiments that are derived from what is disclosed within this application without contributing any inventive endeavor, shall fall within the scope the present application claims.

Throughout the description of the present disclosure, spatially relative terms, such as “upper,” “lower,” “left,” “right,” “front,” “rear,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures.

It will be understood that, although the terms “first,” “second” etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. Thus, a feature that defines “first,” “second” may expressly or implicitly include at least one of the features. In addition, the technical solutions between the various embodiments may be combined with each other, but must be based on the implementation by a person skilled in the art. When the combination of technical solutions is contradictory or impossible to achieve, it should be considered that the combination of such a solution doesn't exist and is not in the scope of the appended claims of the present invention.

The present application discloses a display driving method.

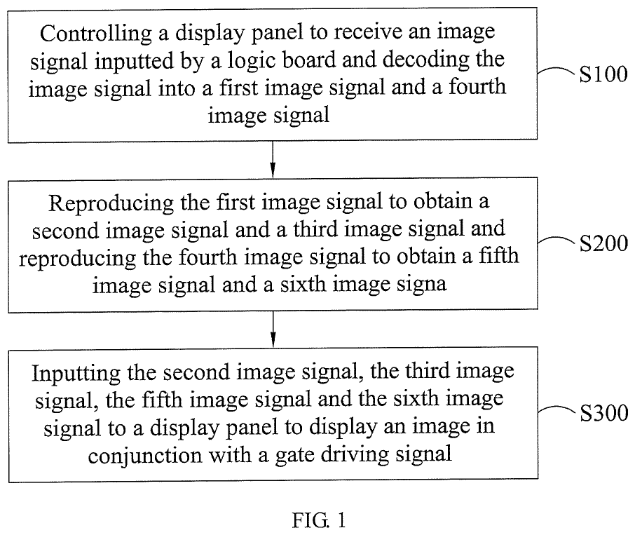

Referring to FIG. 1, in one embodiment of the present invention, the display driving method may be applied to an ultra-high-definition display panel which can be driven by a FHD (Full High Definition) TCON (Timer Control Register, i.e., a logic board), as an example. The display driving method comprises the steps of:

S100, receiving an input image signal and decoding the input image signal into a first image signal and a fourth image signal;

S200, reproducing the first image signal to obtain a second image signal and a third image signal, and reproducing the fourth image signal to obtain a fifth image signal and a sixth image signal;

S300, inputting the second image signal, the third image signal, the fifth image signal and the sixth image signal to a display panel to display an image in accordance with a gate driving signal.

It should be noted that the resolution of the FHD image signal is lower than the resolution of the UD image signal. As the display panel is defective, for example, some pixels in the display panel may have defects. For UD image signals, the defective display panel is unable to display the image in full. But, for the FHD image signal with a lower resolution, the sensitivity of the human eye to the defects can be lowered.

In this embodiment, the first image signal is a left section image signal, and the fourth image signal is a right section image signal.

In this embodiment, the input FHD image signal is finally divided into four signals which are the second image signal and the third image signal as well as the fifth image signal and the sixth image signal. Each section image signal is responsible for a quarter of the image display to match the UD display panel.

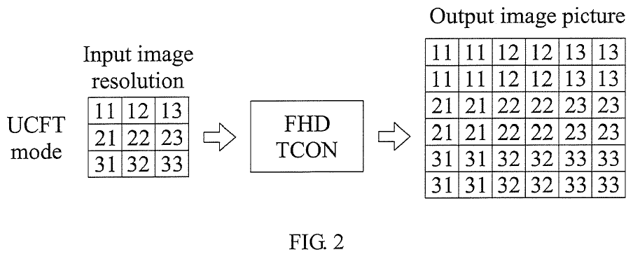

FIG. 2 is a schematic view showing a FHD image signal based on a UD display panel according to the technical solution of the present invention.

For example, the resolutions of the input low-definition image of the input FHD image signal are 11, 12, 13, 21, 22, 23, 31, 32, and 33. After being decoded and reproduced by the FHD TCON, a single pixel data is reproduced to become four. The display effect of the UD display panel is that the adjacent upper, lower, left and right pixels have the same pixel data, such that the FHD image signal is displayed on the UD display panel.

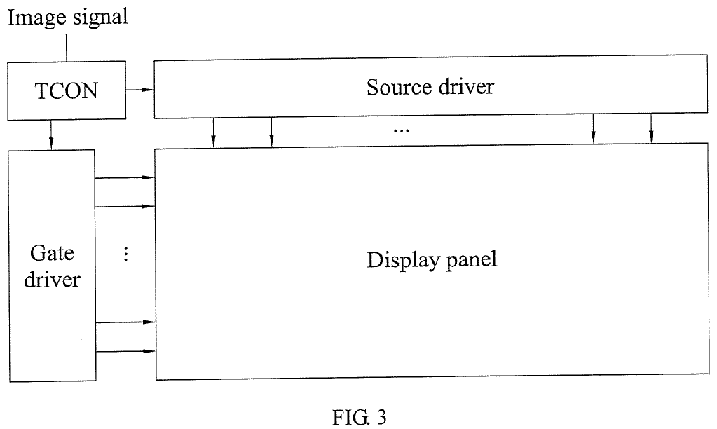

Referring to FIG. 3, IPS, VA, TN, OCB display panels and the like are usually driven by a source driver in cooperation with a gate driver. After the FHD image signal is input to the TCON, a data signal and a clock control signal of the source driver and the gate driver are generated after the conversion processing. Specifically, the source driver is to load the data signal and the gate driver is to control the timing sequence to realize the scanning display of the image.

The technical solution of the present invention is that the input FHD image signal is decoded to obtain the first image signal and the fourth image signal, and the first image signal is reproduced and divided into two lines of identical signals, and the right section image signal is reproduced and divided into two lines of identical signals so as to obtain four lines of image signals required for the UD display panel, i.e., the second image signal, the third image signal, the fifth image signal and the sixth image signal, and in conjunction with the gate driving signal of the display panel, the FHD image signal is displayed on the UD display panel. Compared to the conventional UD driving method, through the FHD driving method to display the FHD image signal on the UD display panel, the hardware cost is greatly reduced, thereby reducing the overall cost of the defective products of the UD glass panels.

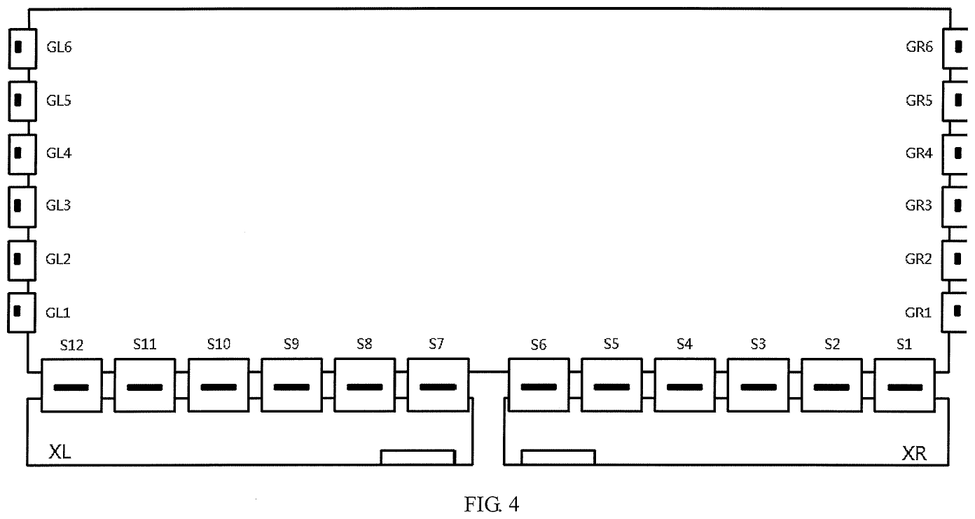

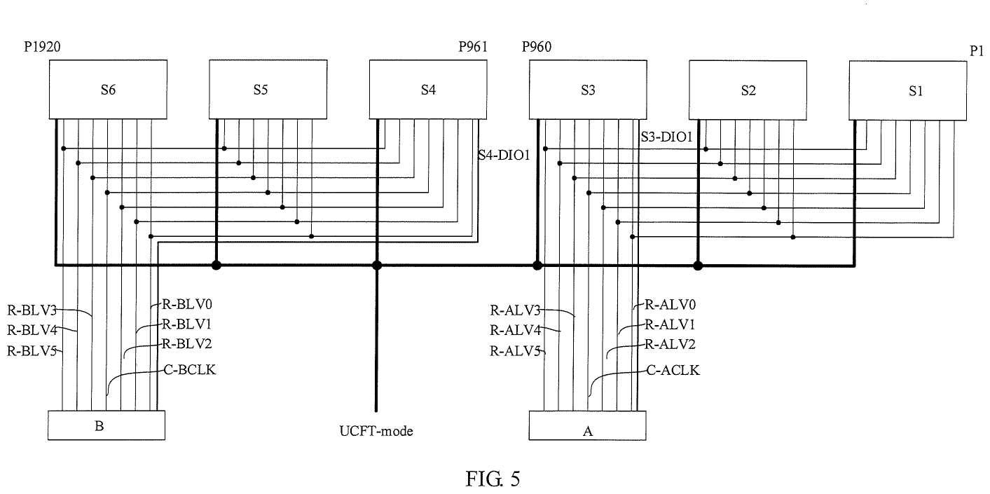

Referring to FIG. 4 and FIG. 5, this embodiment adopts UD 1D1G drive architecture (wherein D denotes a data line, G denotes a scan line, and the independent input number of both the data line and the scan lines is 1). The drive architecture includes M source drivers and M gate drivers. Wherein, M source drivers and M gate drivers are disposed symmetrically. M is a positive integer. In the actual design, the number of the source drivers and the number of the gate drivers are flexible. For example, M may be 12.

In the actual configuration, twelve source drivers are divided into two groups. Each group has six source drivers. Wherein, every three source drives share a data interface. Thus, twelve source drivers include four data interfaces to receive four image signals input from the FHD TCON, respectively.

As the structures of the left and right groups of the source drivers are exactly the same, only the right group is explained hereinafter.

The right group includes the source drivers S1, S2, S3, S4, S5, and S6 arranged in order to the left. Each source driver includes one clock line, six data lines and one data transmission trigger line. The source drivers S1, S2, S3 share one data interface, and the source drivers S4, S5, S6 share one data interface.

For S1, S2, S3, the respective six data lines are each short circuited, the clock lines are each short circuited, the data transmission trigger lines are each short circuited, and then all the lines are guided out from the interface A to be connected with the TCON. Similarly, S4, S5, S6 are short circuited and then guided out from the interface B. The lines guided out from the interface A include one clock line R-ACLK and six data lines R-ALV0 to R-ALV5. The lines guided out from the interface B include one clock line R-BCLK and six data lines R-BLV0 to R-BLV5. The interfaces A, B further include data transmission trigger lines S3-DIO1, S4-DIO2. In addition, the right group further includes a mode switching line UCFT mode which is connected with S1, S2, S3, S4, S5, and S6 respectively for the switching between the UD mode and the FHD mode.

It is easy to understand that the left group includes a C interface and a D interface. The lines guided out from the interface C include one clock line R-CCLK and six data lines R-CLV0 to R-CLV5. The lines guided out from the interface D include one clock line R-DCLK and six data lines R-DLV0 to R-DLV5. The interfaces C, D further include data transmission trigger lines S9-DI03, S10-DI04. In addition, the left group further includes a mode switching line UCFT mode which is connected with S7, S8, S9, S10, S11, and S12 respectively for the switching between the UD mode and the FHD mode.

Each source driver drives 320 columns of pixels, and twelve source drivers drive 3840 columns of pixels.

This embodiment further comprises twelve gate drivers GR1 to GR6 and GL1 to GL6, respectively. GR1 to GR6 are located at the right side of the display panel, and GL1 to GL6 are located at the left side of the display panel. Each gate driver drives 360 rows of pixels. In this embodiment, there are 2160 rows of pixels, P1 to P2160. In particular, the gate driving signal drives the scan lines of the display panel in pairs, that is, the gate driving signal first drives P1/P2, and then P3/P4, P5/P6 . . . up to P2159/P2160.

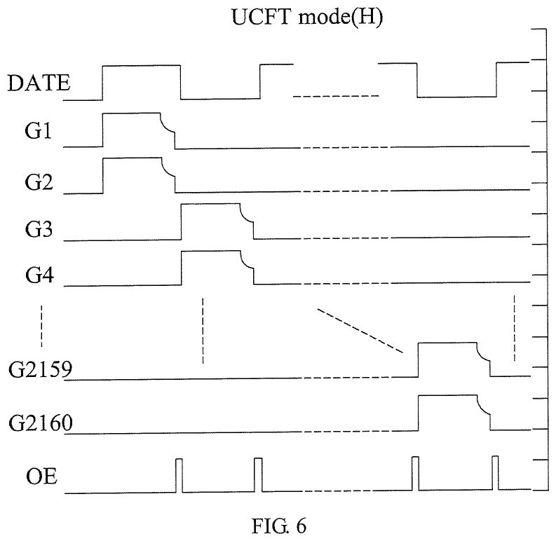

FIG. 6 is a waveform diagram of the gate drive. Referring to FIG. 6, the gate driving signals G1 to G2160 are arranged in pairs. The driving signals in pairs drive P1 to P2160 sequentially. Wherein, OE is an enable signal, and DATE is a data clock signal.

In this embodiment, the second image signal and the third image signal are differential signals. That is, the input of the interfaces A, B, C, D is mini LVDS.

Specifically, the step of “reproducing the first image signal to obtain the second image signal and the third image signal and reproducing the fourth image signal to obtain the fifth image signal and the sixth image signal” includes receiving the first image signal as inputted after signal lines of the second image signal are each connected with signal lines of the third image signal and receiving the fourth image signal as inputted after signal lines of the fifth image signal are each connected with signal lines of the sixth image signal. In this embodiment, the input lines of the source drivers are short circuited to reproduce the signals.

Specifically, the second image signal, the third image signal, the fifth image signal and the sixth image signal each include two lines of RGB pixel signals. That is, the second image signal, the third image signal, the fifth image signal and the sixth image signal are divided into two groups of pixel signals, respectively.

It should be noted that, for example, R-ALV0 to R-ALV2 are input with one RGB pixel signal, and R-ALV3 to R-ALV5 are input with one RGB pixel signal.

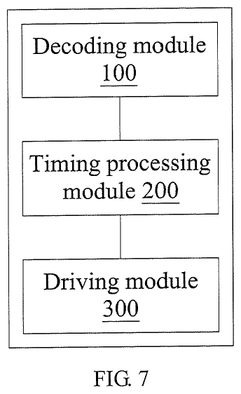

Referring to FIG. 7, the present invention also discloses a display driving device. The display driving device may be applied to a display, a flat panel display, a television display, a computer display, etc. Wherein, the flat panel display is, for example, a liquid crystal display, a plasma display, an electroluminescent display, and so on. The device comprises a decoding module 100, a timing processing module 200, and a driving module 300.

The decoding module 100 receives an input image signal and decodes the input image signal into a first image signal and a fourth image signal.

The timing processing module 200 reproduces the first image signal to obtain a second image signal and a third image signal and reproduces the fourth image signal to obtain a fifth image signal and a sixth image signal.

The driving module 300 is inputs the second image signal, the third image signal, the fifth image signal and the sixth image signal to a display panel to display an image in conjunction with a gate driving signal.

In particular, the gate driving signal drives scan lines of the display panel in pairs.

Preferably, both the second image signal and the third image signal are differential signals.

In particular, the timing processing module receives the first image signal as inputted after signal lines of the second image signal are each connected with signal lines of the third image signal and receives the fourth image signal as inputted after signal lines of the fifth image signal are each connected with signal lines of the sixth image signal.

Specifically, the second image signal, the third image signal, the fifth image signal and the sixth image signal are grouped as two lines of pixel signals, respectively. That is, the second image signal, the third image signal, the fifth image signal and the sixth image signal each include two lines of RGB pixel signals.

The technical solution of the present invention effectively reduces the driving cost of the display panel based on the UD architecture.

It will be understood by those skilled in the art that the present invention provides a display driving device. The display driving device comprises a processor and a nonvolatile memory. The nonvolatile memory stores executable instructions. The processor executes the executable instructions for achieving the above methods described in the various embodiments. It will be further understood by those skilled in the art that the modules/units 100, 200, 300 shown in FIG. 7 may be software modules or software units. In addition, the various software modules or software units may be inherently stored in the nonvolatile memory and executed by the processor.

The present invention also provides a display device. The display device comprises a display panel, a drive unit, and a display driving device as described above. The display driving device comprises a decoding module, a timing processing module, and a driving module. The decoding module receives an input image signal and decodes the input image signal into a first image signal and a fourth image signal. The timing processing module reproduces the first image signal to obtain a second image signal and a third image signal and reproduces the fourth image signal to obtain a fifth image signal and a sixth image signal, and grouping the second image signal, the third image signal, the fifth image signal and the sixth image signal as two lines of pixel signals respectively. The driving module inputs the second image signal, the third image signal, the fifth image signal and the sixth image signal to a display panel to display an image in conjunction with a gate driving signal.

The specific structure of the display driving device is directed to the embodiment described above. Since the display device adopts all the technical solutions of all of the above-described embodiments, the display device has at least all of the advantageous effects of the technical solutions of the above embodiments.

In some embodiments, the display device of the present invention may be a liquid crystal display device, an OLED display device, or other display devices which may include a liquid crystal television, a computer liquid crystal display, a notebook computer, or the like.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A driving method of a display panel, comprising the steps of:
controlling the display panel to receive an image signal inputted by a logic board and decoding the image signal into a first image signal and a fourth image signal;
reproducing the first image signal to obtain a second image signal and a third image signal and reproducing the fourth image signal to obtain a fifth image signal and a sixth image signal; and
inputting the second image signal, the third image signal, the fifth image signal and the sixth image signal to the display panel, so as to display an image in conjunction with a gate driving signal.

2. The driving method as claimed in claim 1, wherein the second image signal and the third image signal are differential signals.

3. The driving method as claimed in claim 1, wherein the step of reproducing the first image signal to obtain the second image signal and the third image signal and reproducing the fourth image signal to obtain the fifth image signal and the sixth image signal includes receiving the first image signal as inputted after signal lines of the second image signal are each connected with signal lines of the third image signal and receiving the fourth image signal as inputted after signal lines of the fifth image signal are each connected with signal lines of the sixth image signal.

4. The driving method as claimed in claim 3, wherein the gate driving signal drives scan lines of the display panel in pairs.

5. The driving method as claimed in claim 1, wherein the second image signal, the third image signal, the fifth image signal and the sixth image signal are grouped as two lines of pixel signals respectively.

6. The driving method as claimed in claim 1, wherein the display panel includes M source drivers and M gate drivers, and M is a positive integer.

7. The driving method as claimed in claim 6, wherein each of the source drivers includes one clock line, six data lines, and one data transmission trigger line.

8. A driving device of a display panel, comprising:
a decoding module receiving an input image signal and decoding the input image signal into a first image signal and a fourth image signal;
a timing processing module reproducing the first image signal to obtain a second image signal and a third image signal and reproducing the fourth image signal to obtain a fifth image signal and a sixth image signal; and
a driving module inputting the second image signal, the third image signal, the fifth image signal and the sixth image signal to the display panel to display an image in conjunction with a gate driving signal.

9. The driving device as claimed in claim 8, wherein the second image signal and the third image signal are differential signals.

10. The driving device as claimed in claim 9, wherein the timing processing module receives the first image signal as inputted after signal lines of the second image signal are each connected with signal lines of the third image signal and receives the fourth image signal as inputted after signal lines of the fifth image signal are each connected with signal lines of the sixth image signal.

11. The driving device as claimed in claim 10, wherein the gate driving signal drives scan lines of the display panel in pairs.

12. The driving device as claimed in claim 8, wherein the display panel includes M source drivers and M gate drivers, and M is a positive integer.

13. The driving device as claimed in claim 12, wherein each of the source drivers includes one clock line, six data lines, and one data transmission trigger line.

14. A display device, comprising:
a display panel;
a driving component; and
the driving device of the display panel as claimed in claim 8, the driving device comprising:
a decoding module receiving an input image signal and decoding the input image signal into a first image signal and a fourth image signal;
a timing processing module reproducing the first image signal to obtain a second image signal and a third image signal and reproducing the fourth image signal to obtain a fifth image signal and a sixth image signal; the second image signal, the third image signal, the fifth image signal and the sixth image signal being grouped as two lines of pixel signals respectively; and
a driving module inputting the second image signal, the third image signal, the fifth image signal and the sixth image signal to the display panel to display an image in conjunction with a gate driving signal.
